(19) United States
(12) Patent Application Publication
(10) Pub. No.: US 2016/0336697 A1
(43) Pub. Date: Nov. 17, 2016

(54) HF COAXIAL CABLE WITH ANGULAR PLUG CONNECTION, AND A METHOD FOR PRODUCING SAME

(71) Applicant: Spinner GmbH, Westerham (DE)

(72) Inventors: Bernd Zimmerhaeckel, Glashutte (DE); lngolf Fischer, Liebenau (DE); Falk Mutze, Liebenau (DE)

(21) Appl. No.: 15/220,796

(22) Filed: Jul. 27, 2016

Related U.S. Application Data
(62) Division of application No. 14/415,823, filed on Jan. 20, 2015.

(51) Int. Cl. H01R 24/54; H01R 43/04; H01R 24/56

(52) U.S. Cl. CPC H01R 24/545; H01R 24/564; H01R 43/04; H01R 2103/00

(57) ABSTRACT

The invention relates to a method for producing a HF coaxial cable that comprises a cable inner conductor and a cable outer conductor, as well as an angular plug connection at at least one of its two cable ends. The method comprises steps of providing a straight HF corrugated cable including a cable outer conductor, preparing the cable end by trimming the HF corrugated cable, connecting a straight plug connector to the prepared cable end; and cold forming a region of the HF corrugated cable by applying a bending force directed transversely to a longitudinal extent of the HF corrugated cable and a tensile force directly longitudinally to the HF corrugated cable to permanently bend the HF corrugated cable to have a bending radius which alters line impedance to be a maximum of 1 ohm.

### CROSS REFERENCE TO RELATED APPLICATIONS

This application is a divisional of application Ser. No. 14/148,823 which application is incorporated herein by reference in its entirety. Reference is also made to PCT/EP2013/002153, filed Jul. 19, 2013 and to DE 10 2012 014 425.3, filed Jul. 20, 2012, the complete disclosures of which are hereby incorporated herein by reference in their entirety for all purposes.

### TECHNICAL FIELD

The invention relates to an HF coaxial cable that comprises a cable inner conductor and a cable outer conductor, as well as an angular plug connection at at least one of its two cable ends.

### PRIOR ART

HF angular plug connections of the above type allow a substantially loss-free HF signal redirection, preferably by 90°, and are typically used for purposes of HF signal coupling into or HF signal coupling out of HF device components. Particularly advantageous is the only small overall height of such angular plug connections, which enables a reliable HF signal connection for the first time, principally in narrow installation spaces, as are often prevalent on the rear walls of devices.

An HF coaxial angular plug connector of the generic type is described in the published document DE 198 54 503 C1, which provides a plug connector inner conductor, which is centered by means of an insulating support of dielectric material within a metal housing, which at the same time constitutes the plug connector outer conductor. A receptacle opening for an HF coaxial cable assembled at the front is provided at right angles to a housing axis that can be allocated to the metallic housing. For the purpose of securely joining the cable inner and outer conductors to the corresponding inner and outer conductor regions provided on the housing side, an access opening that can be closed at the side on the metallic housing is provided, through which soldered connections between the respective inner and outer conductors have to be undertaken, but which are viewed as complicated installation steps and thus contribute a considerable portion of the production costs.

An angular plug connection for high-frequency coaxial cables is known from DE 38 36 141 A1, which can be realized with lower production costs owing to the simpler construction thereof. The known angular plug connection to this end provides a flexible HF coaxial cable. The cable outer conductor is a wire mesh and the assembled cable end thereof is connected to a specially shaped straight plug connector. The plug connector has a contact sleeve surrounding the cable outer conductor, which has a sleeve opening, which makes it possible to bend the sleeve region including the inner coaxial cable through 90°. The bending of the sleeve regions ensures that the cable inner conductor retains its insulation in the region of the angling. The radius of curvature of cable inner conductor and cable outer conductor is dimensioned such that the wave impedance of the coaxial cable remains constant, particularly in the region of the kink. For the purposes of plug stabilization, protection and also improved handling, the ready-installed plug is encapsulated with a corresponding plastic coating.

The coaxial cable described in the published document DE 103 50 763 A1 provides a similarly simple construction with an angular plug connection, in which the redirection through 90° for the HF signal line is realized by bending a flexible coaxial cable. In this case, the assembled coaxial cable end is connected to a straight plug connector, which is known per se. The HF coaxial cable set thereof, which protrudes directly out of the plug connector, has a 90° bend. A moulded part of a thermoplastic is used for maintaining the shape thereof. The flexible HF coaxial cable has an outer conductor formed from a metal mesh.

The published document DE 18 01 189 A discloses a right-angled coaxial-cable connector, with reduced electrical losses. Reference is expressly made to the fact that electrical losses increase in the case of deformations of a coaxial cable with radii that are too narrow. It is suggested to bend the coaxial cable in a gentle arc. A slot-shaped recess additionally is introduced in a plug housing part. Through the recess the cable is formed in the forming region into a gentle arc to the greatest extent possible.

The published document FR 2 503 942 A1 is concerned with the production of a bent semi-rigid cable, avoiding mechanical and electrical discontinuities in the outer conductor, which can occur in the form of microtears due to the deformation process, to the greatest extent possible. It is suggested to electrolytically coat the outer conductor after the bending of the semi-rigid cable, e.g. with a layer thickness of 2.2 mm, in order to improve the electrical properties.

Finally, the published document DE 30 48 781 A1 discloses a flexible coaxial cable with an outer-conductor mesh constructed as an outer conductor. It is suggested to remove the outer layer of the coaxial cable in the bending region, so that the outer conductor mesh is exposed. Subsequently, the coaxial cable is bent and the bend is fixed by a setting material. Solders or resin-based adhesives are preferred as setting material.

### SUMMARY OF THE INVENTION

The invention is based on developing a HF coaxial cable, particularly in the form of a corrugated sheath cable, with a cable inner conductor and cable outer conductor and also an angular plug connection at at least one of the two cable ends thereof in such a manner that the production outlay should be reduced considerably, whereby the high-frequency signal transmission properties are improved significantly, particularly at high frequencies, for example greater than 4 GHz. It is necessary that the sizes, that is to say particularly the overall heights of hitherto-known angular plug connectors are not exceeded, but rather are reduced. It should be possible to implement all of the measures to be met for this using, in terms of process engineering, simple means, particularly of assembling factories. Also, the diversity of parts required to be stocked for producing the angular plug connection, the logistics and storage outlay should be reduced considerably.

The solution of the object on which the invention is based is specified in Claim 1. The subject matter of Claim 8 is a method for producing an angular plug connection. Features which advantageously form the idea according to the solution are the subject of the subclaims and also to be drawn from the further description, particularly with reference to the illustrated exemplary embodiments.

A HF coaxial cable constructed according to the solution having the features of the preamble of Claim 1 is characterised by a conventional corrugated sheath cable, which is known per se, having a cable outer conductor constructed as a metal corrugated tube and a cable inner conductor, to which a line impedance Zₖ and also a minimum bending radius r_{k,min}, which is for the most part determined by the cable manufacturer, are allocated. A straight plug connector is attached at at least one cable end. For connection to the plug connector, the at least one cable end of the corrugated sheath cable is assembled, that is to say the cable inner conductor exposed at the end is joined with an inner conductor of the straight plug connector and the cable outer conductor is joined with an outer conductor of the straight plug connector. Directly or indirectly following the straight plug connector, the corrugated sheath cable has a bend that has a bending radius r_{α}, which is significantly smaller than the minimum bending radius r_{k,min} predetermined by the cable manufacturer. In accordance with the invention, significantly smaller means a bending radius r_{α}, for which the following applies: 0.2 r_{k,min}≦r_{α}≦0.9 r_{k,min}, preferably 0.3 r_{k,min}≦r_{α}≦0.7 r_{k,min}, particularly preferably 0.4 r_{k,min}≦r_{α}≦0.6 r_{k,min}.

In addition, the bent corrugated sheath cable dimensioned according to the invention has a line impedance Z_{α}, for which the following applies:

|Zα−Zₖ|≦1Ω

That is in spite of bending the corrugated sheath cable with a significantly smaller bending radius than that which is predetermined as the minimum bending radius by the manufacturer, the HF coaxial cable with angular plug connection according to the invention has HF transmission qualities, which correspond or at least substantially correspond to those of an undeformed corrugated sheath cable. The HF coaxial cable according to the invention is therefore characterized in particular by a bend with the bending radius r_{α}, which is produced by cold forming the corrugated sheath cable with the introduction of a bending force transversely to the corrugated sheath cable and also a tensile force along the corrugated sheath cable. By means of the mutually adjusted introduction of force with reference to the bending and tensile forces, it is ensured that the corrugated sheath cable geometry, which is characteristic for a loss-free HF signal propagation along the corrugated sheath cable, is not or at least is not appreciably changed by the bending. The corrugated sheath geometry characteristic for the HF signal propagation is in particular understood to mean an electrically effective diameter of the corrugated sheath cable, which corresponds to half the sum of one maximum and minimum diameter in each case that can be allocated to the cable outer conductors, which are constructed in a corrugated manner. For an unhindered HF signal propagation along the corrugated sheath cable section bent according to the invention, the electrical diameter of the corrugated sheath cable deviates in the region of the bending radius r_{α} by less than 10% from the electrical diameter in the remaining, that is a non-bent or -shaped corrugated sheath cable region.

Due to the bending of the corrugated sheath cable according to the invention with the required bending radii far below the minimum bending radii specified by the manufacturer, although the concept according to the invention uses the known HF coaxial cable angular plug connections, in which the HF signal propagation direction at 90° is realized by bending a correspondingly flexibly configured coaxial cable. The concept according to the invention goes beyond in a targeted manner the technically acceptable use limits imposed by the manufacturer in the case of corrugated sheath cables with respect to not undershooting a predetermined minimum bending radii. The significant undershooting of the bending radius initially creates the prerequisite of creating compact overall heights for the construction of an angular plug connection based on a corrugated sheath cable, which has overall heights comparable with the overall heights of conventional angular plug connections. However, due to the use of corrugated sheath cables bent according to the invention, in contrast with conventional coaxial cables with angular plug connections, in addition to a simpler installation or production of the angular connection, explained hereinafter, significantly better signal transmission qualities result, particularly in the case of frequencies of greater than 4 GHz.

The HF coaxial cable with an angular plug connection according to the invention can fundamentally be realized with corrugated sheath cables of all standardized diameter classes from ⅛″ to ⅝″. Thus, for corrugated sheath cables with a nominal diameter of ⅛″, a minimum bending radii r_{α} of 4 mm to 10 mm can be realized according to the invention with the minimum bending radius r_{k,min} specified by the manufacturer typically being specified as 18 mm. In the case of ¼″ corrugated sheath cables, minimum bending radii r_{α} of 5 mm to 15 mm can be realized with r_{k,min} typically being 25 mm. For corrugated sheath cables with a nominal diameter of ⅜″, a minimum bending radii r_{α} of 7 mm to 20 mm can be realized, for which a minimum bending radius r_{k,min} of 25 mm being specified by the manufacturer. Finally, for ½″ corrugated sheath cables, a minimum bending radii r_{α} between 9 and 25 mm can be realized with r_{k,min} at 32 mm being specified by the manufacturer. All commercially available corrugated sheath cables are fundamentally suitable for realizing a HF coaxial cable with angular plug connector according to the invention which relates to standardized corrugated sheath cables, particularly also super-flexible corrugated sheath cables, which have a spiral-corrugated outer conductor contour that is with a pitch.

To produce the HF coaxial cable with angular plug connection according to the invention, at least one cable end needs to be assembled initially and the cable outer conductor and also the cable dielectric are trimmed with respect to the cable inner conductor. If present, the cable sheath protecting the HF corrugated sheath cable is likewise trimmed in certain areas.

In a next step, a straight plug connector is securely connected to the previously explained prepared cable end by joining the cable inner conductor to the inner conductor of the straight plug connector and the cable outer conductor to an outer conductor of the straight plug connector, preferably by soldering, crimping or similar joining methods. Of course, releasably secure joining techniques can also be used. For example, the cable inner conductor can be connected to a plug-side inner conductor structure by laminating or spring-loaded contacting. The installation outlay required for this is far lower compared to angular plug connectors composed of a plurality of components, as are known from the published document DE 198 54 503 C1 discussed above.

Subsequently, it is necessary to bend the corrugated sheath cable emanating from the plug connector in a straight line in one region which preferably directly follows the plug connector. The bending process takes place by means of cold forming under the action of a bending force directed transversely to the longitudinal extension of the HF corrugated sheath cable and a tensile force orientated longitudinally to the HF corrugated sheath cable, in such a manner that the corrugated sheath cable experiences a permanent bend with a bending radius r_{α}, where r_{α}≦r_{k,min}, directly or indirectly following the straight plug connector. This bending alters the line impedance Zₖ of the straight-running, undeformed corrugated sheath cable by a maximum of 1 ohm, as a result of which the return loss aᵣ of the conventional corrugated sheath cable can be changed as a function of the frequency by up to 2% due to the bend of the bending radius r_{α}.

The tensile force additionally acting along the corrugated sheath cable as a function of the bending force acting on the corrugated sheath cable is chosen under the proviso of stretching the corrugation contour of the cable outer conductor facing radially inwards to the bending radius on the one hand, so that a direct mutual bearing of adjacent corrugated structure side faces is counteracted. But on the other hand, the formation of tears, owing to overextension or overstretching, on the outer conductor surface radially outwardly facing the bend is eliminated.

Optionally, the cold formed bending region of the corrugated sheath cable is provided with an envelope, which exerts both a protection and support function for the bent region of the HF corrugated sheath cable. The bent cable region with the plug connector connected thereto is advantageously inserted into a correspondingly prefabricated casting mould and in the context of a subsequent moulding process, provided with a corresponding envelope using a suitably chosen thermoplastic material. Depending on the functional demand, the bent corrugated sheath cable region can alternatively be protectively surrounded with a hot adhesive, a shrink-fit hose or a suitably constructed protective sleeve.

With the previously described method, HF angular plug connectors can be realized, which are characterized by the use according to the invention of a HF corrugated sheath cable whose bend according to the invention, which is created by cold forming, has a significantly smaller bending radius than the minimum bending radius permitted by the manufacturer in each case. Thus, for example, an angular plug connector constructed according to the invention using a ¼″ corrugated sheath cable has an overall height of just approx. 40 mm. Although an overall height of this type can be realized with conventional angular plug connections, it cannot be realised using a conventional straight plug connection on a corrugated sheath cable, which would be bent minimally in accordance with manufacturer instructions and would furthermore permanently have HF transmission qualities that comply with the technical standard.

In another embodiment, the region of the cable is not bent directly following the straight plug connector along the corrugated sheath cable. Instead, the bend is rather in a suitable region, which lies spaced apart from the at least one plug connector attached to the cable at the end. Although the main aspect of the HF coaxial cable with angular plug connection according to the invention typically provides a bending angle β of 90° with a tolerance range of ±5°, i.e. 85°≦β≦95°, bends along the corrugated sheath cable are also conceivable with bending angles, β, which deviate therefrom, for example β=60°.

The dimensional shape of the angular plug connection and associated therewith the bending angle can be permanently fixed, for example by providing thermoplastically injection moulded geometries at the manufactured angular plug connection like webs, bulges, lobes, sieve-like structures. These geometries do not require additional effort and can be used for further functions like labels, attached caps, embedded functional parts etc.

Also, a plurality of bending regions can clearly be provided along a HF corrugated sheath cable, too, using the suggested cold forming method.

### BRIEF DESCRIPTION OF THE DRAWINGS

The invention is described by way of example in the following without limitation of the general inventive idea on the basis of exemplary embodiments with reference to the drawings. In the figures:

FIG. 1 shows a longitudinal section through an HF coaxial cable with an angular plug connection constructed according to the invention;

FIG. 2 shows a longitudinal section through a bent corrugated sheath cable for illustration of the electrical diameter;

FIG. 3 shows a longitudinal section through a straight plug connector attached on the cable end of a corrugated sheath cable;

FIGS. 4a-c show a sequential image illustration for cold forming according to the invention of the corrugated sheath cable with straight plug connector;

FIG. 5 shows an alternative bending device for a corrugated sheath cable for producing the smallest bending radii; and

FIG. 6 shows a graph for comparing the standing wave ratio between a straight connection, a bent embodiment according to the invention and a conventional angular plug connection with mountable plug connection.

### DESCRIPTION OF THE PREFERRED EMBODIMENTS

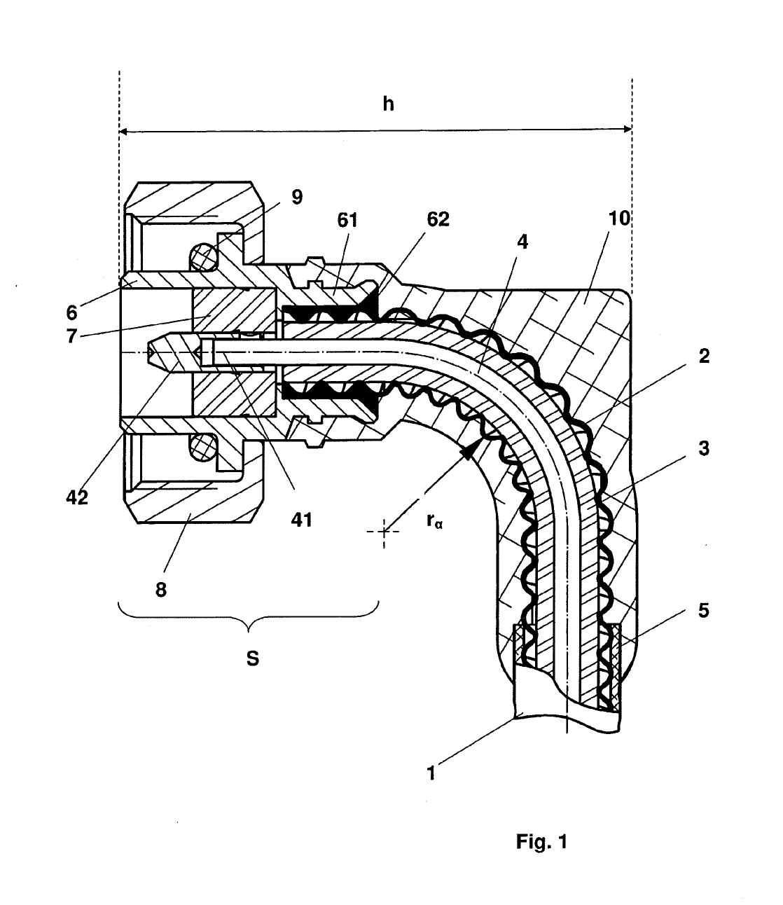

FIG. 1 shows a longitudinal sectional illustration for an HF coaxial cable with an angular plug connection constructed according to the invention. The HF coaxial cable used according to the invention constitutes a conventional corrugated sheath cable 1, which has a cable outer conductor 2, which is corrugated in a spirally undulated manner, and also a cable inner conductor 4, which is guided centrally to the cable outer conductor 2 inside a cable dielectric 3. The cable outer conductor 2 is typically encapsulated by a plastic envelope 5.

The cable end of the corrugated sheath cable 1 of FIG. 1 has a protruding end 41 of the cable inner conductor 4 opposite a trimmed cable dielectric 3 and a cable outer conductor 2. The end 41 of the cable inner conductor 4 leads into a receptacle opening inside an inner conductor 42 provided on the plug side which is gripped in a component 7 to provide electrical insulation with respect to a plug-side outer conductor 6. The end of the cable outer conductor 2 is surrounded on the outside by an accommodating sleeve 61 of the plug outer conductor 6, and is securely joined to the same, preferably by means of a solder connection 62. A union nut 8 is additionally attached externally on the plug outer conductor 6 such that it can move longitudinally and cannot be lost. The plug connector S, which is securely connected to the corrugated sheath cable 1 at the end in FIG. 1, constitutes a straight plug connector that is known per se. It is possible to use customary joining techniques that are simple to master for the attachment thereof on the prefabricated cable end of the corrugated sheath cable 1. In addition, an envelope 10 is provided around the bent region of the corrugated sheath cable 1, which is not covered with the cable covering 5. The envelope can preferably be produced by a thermoplastic forming process and in addition to it providing a mechanical support function, the thermoplastic also ensures a sealing and protecting function with respect to external influences.

The novelty of the angular plug connection illustrated in FIG. 1 on the one hand lies in the use of the corrugated sheath cable 1, on the assembled cable end of which a straight to which a conventional plug connector S is attached with the corrugated sheath cable 1 having a bend, having a uniform bending radius r_{α}. The bending radius according to the invention is chosen to be significantly smaller than a minimum bending radius r_{k,min} specified as a minimum by the manufacturer of the corrugated sheath cable 1. Only by significantly undershooting the minimum bending radius r_{k,min} permitted by the manufacturer can an angular plug connection be achieved, with the overall height h corresponding to or undercutting the dimensions of known angular plug connections.

The actually achievable bending radius r_{α} is dimensioned on a circumferential contour facing the inward bend along the cable outer conductor 2, which comes into contact with a correspondingly fitted bending tool, as is also described below. Additional application-specific properties can be realized with the envelope.

The bending of the corrugated sheath cable 1 takes place in a cold forming process, which is performed with sufficient care to not impair the electrically effective diameter dₑ. The electrically effective diameter dₑ for a corrugated sheath cable 1, which has a decisive influence on the HF signal transmission along the corrugated sheath cable 1, is composed of half of the sum of the maximum and minimum diameter of the corrugated sheath cable 1 results from the corrugated cable outer conductor structure thereof.

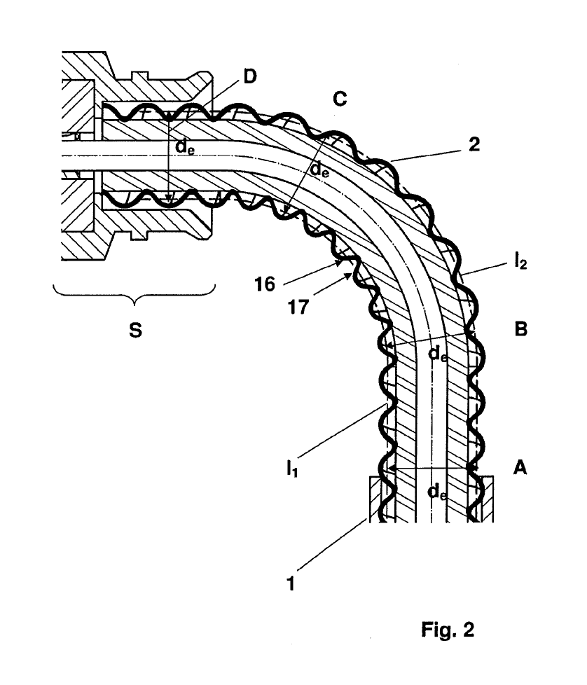

The dielectric diameter dₑ is illustrated with two dashed lines l₁ and l₂ in FIG. 2 which is a longitudinal section of a bent corrugated sheath cable 1. The cable 1 is connected at one end to a straight plug connector S, which is explained in more detail in conjunction with FIG. 1. Both dashed lines l₁ and l₂ run centrally through the corrugated cross-sectional contour of the cable outer conductor 2. In order to retain the required unchanged HF transmission qualities along the corrugated sheath cable 1 in spite of significant undershooting of the minimum bending radius r_{k,min} defined by the manufacturer, it is necessary to carry out the bending along the corrugated sheath cable 1 with unchanged dielectric diameter dₑ. The electrically effective diameters dₑ at the representatively indicated cable points A, B, C, D are ideally identical. A tolerable deviation of the actual cable diameter at the points C, B compared to a non-bent cable region, for example A, D may be 10% at most.

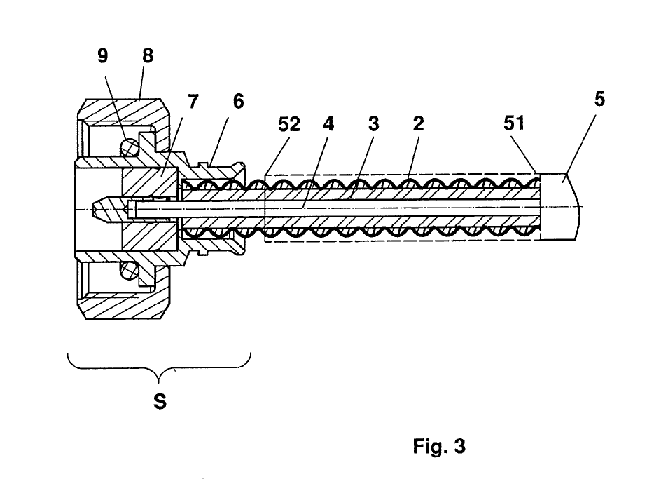

To produce the angular plug connection according to the invention, a straight end of a corrugated sheath cable 1 is prepared and provided by trimming the outer cable sheath 5 as far as the cable sheath end 51 of the cable outer conductor 2 and of the cable dielectric 3, as it were, with respect to the cable inner conductor 4 (cf. FIG. 3). It may only be mentioned for the sake of completeness that the cable sheath 5 is only shortened as far as the cable sheath end 52 if no subsequent bending of the cable sheath 1 takes place.

Subsequently, a conventional straight plug connector S can be joined to the assembled cable end, the plug inner conductor 42 being securely connected, for example soldered or crimped, to the exposed cable inner conductor 4. Subsequently, the plug outer conductor 6 is pushed on or alternatively screwed on and soldered, clamped, welded or otherwise securely connected to the cable outer conductor 2. In this case, the straight plug connector S can be completed in advance, for example using a union nut 8, an insulating component 7 or, if necessary, using a seal 9. Alternatively, the straight plug connector S can be a plug, as a coupler or in a hybrid manner.

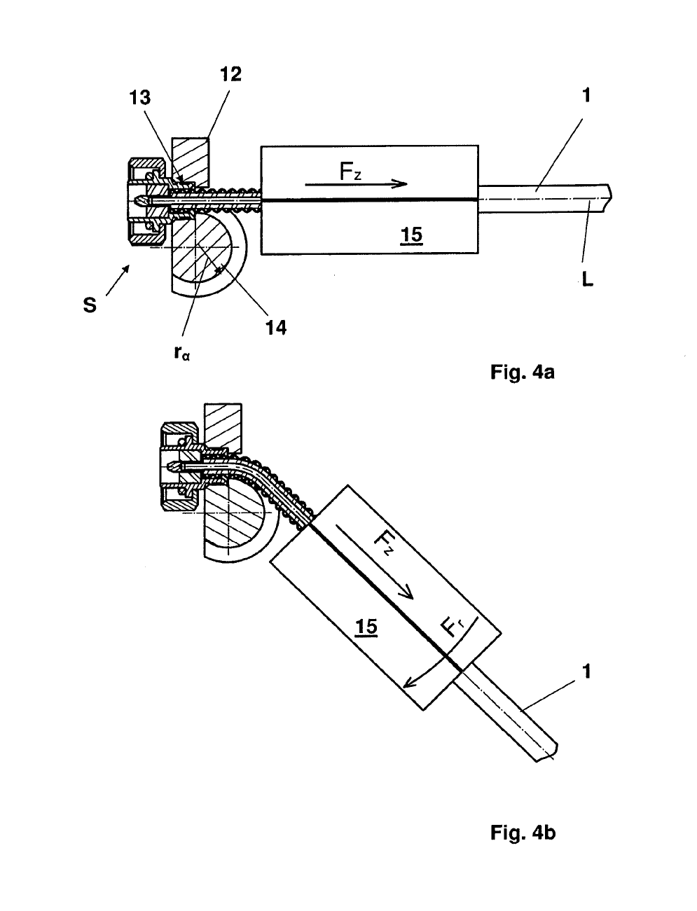

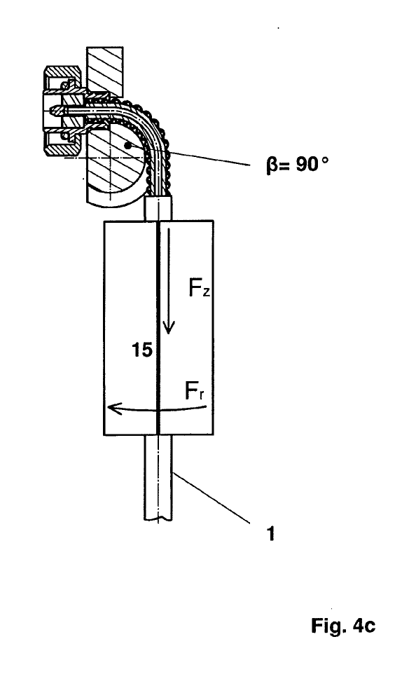

The cold-forming procedure takes place in the next step, which is explained with reference to the FIGS. 4a to c on the basis of a first exemplary embodiment. A retaining means 12 is illustrated in FIG. 4a, which has a receptacle opening 13, which is adapted in an oppositely contoured manner to a supporting section of the plug connection S, so that the straight plug connector S is releasably fixed in a secure manner relatively to the retaining means 12, which is attached in a stationary manner. A bending guide 14 adjoins the retaining means 12 on one side along the corrugated sheath cable 1, the bending contour of which bending guide corresponds to a predetermined bending radius r_{α}. The corrugated sheath cable 1 is connected to a clamping and tensioning device 15 at a distance from the retaining means 12. The clamping and tensioning device creates both a tensile force F_{z} orientated longitudinally along the cable longitudinal extent L and a bending force Fᵣ directed transversely to the cable longitudinal extent L onto the corrugated sheath cable 1, as is illustrated in FIG. 4b. Here, the clamping/tensioning element 15 including corrugated sheath cable 1 is guided around the bending guide 14 in a force-loaded manner, so that the region of the corrugated sheath cable 1 divested of the cable sheath 5 clings to the surface of the bending guide 14 in the manner illustrated in FIG. 4b.

The bending process is ended as soon as the clamping/tensioning element 15 has cold formed the corrugated sheath cable 1 by 90°, as is illustrated in FIG. 4c.

The bending guide 14 advantageously has a concavely constructed contact surface, using which the bending guide 14 comes into contact with at least one eighth, preferably up to a half of the circumferential edge of the corrugated cable outer conductor of the corrugated sheath cable 1. The concave construction of the bending guide 14 supports the shape retention of the cross-sectional geometry of the corrugated sheath cable 1 and, connected therewith, the constant electrically effective diameter dₑ during the cold forming process.

The adaptation of the forces F_{z} and Fᵣ acting on the corrugated sheath cable 1 during the cold forming process is of central importance. In particular, during the choice of the tensile force F_{z} acting along the corrugated sheath cable 1, it is necessary to note that the inner surfaces 16 and 17 of two corrugated guides (cf. FIG. 2), which directly face the bending guide 14, are spaced apart from one another by a corresponding stretching action and not pressed together by the bending process. On the other hand, the tensile force F_{z} must not lead to tears or other material degradations forming on the side of the cable outer conductor 2 facing away from the bending guide 14. Thus, the force contribution of the bending process and acting on the corrugated sheath cable, which is composed of the sum of tensile force F_{z} and bending force Fᵣ, is chosen individually in each case as a function of size and material type and also of the material composition of the corrugated sheath cable. The forming on the one hand constitutes a plastic forming, providing the desired, bent spatial form of the corrugated sheath which is retained without further force contribution, and on the other hand does not lead to any of the previously described material degradations.

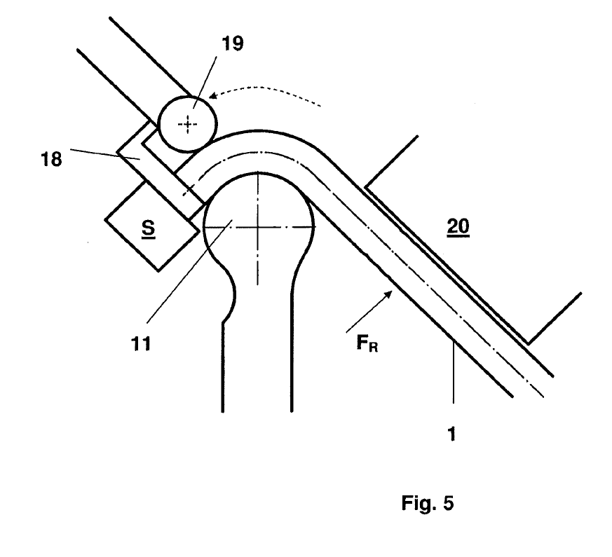

FIG. 5 shows an alternative bending tool with a stationarily attached bending guide 11, to which a retaining means 18 is pivotably attached, into which the straight plug connector S can be inserted in a fixed manner such that it cannot be released. A rolling or sliding body 19 is provided together with the retaining means 18 attached such that it can pivot about the bending guide 11 to which the rolling or sliding body is attached radially spaced apart from the circumferential edge of the bending guide 11. During the pivoting process, the rolling or sliding body 19 exerts a contact force onto the corrugated sheath cable 1, which is directed orthogonally onto the bending guide 11 which causes the corrugated sheath cable 1 to be cold formed on the basis of the bending contour of the bending guide 11. Along the corrugated sheath cable 1, the corrugated sheath cable 1 is pressed against a likewise stationarily attached guide unit 20 with a retaining force F_{R}. As a result, the corrugated sheath cable 1 experiences a tensile stress orientated along the corrugated sheath cable, which together with the bending force leads to the cold forming according to the invention. In this case also, it is necessary to choose the retaining force F_{R}, by means of which the tensile and bending forces explained in connection with the FIGS. 4a to c are predetermined, in such a manner that a forming, which is plastic and maintains the corrugated outer contour of the corrugated sheath cable, is achieved, with there being no considerable deformation or material degradations, which influence the HF transmission properties of the bent corrugated sheath cable, occur.

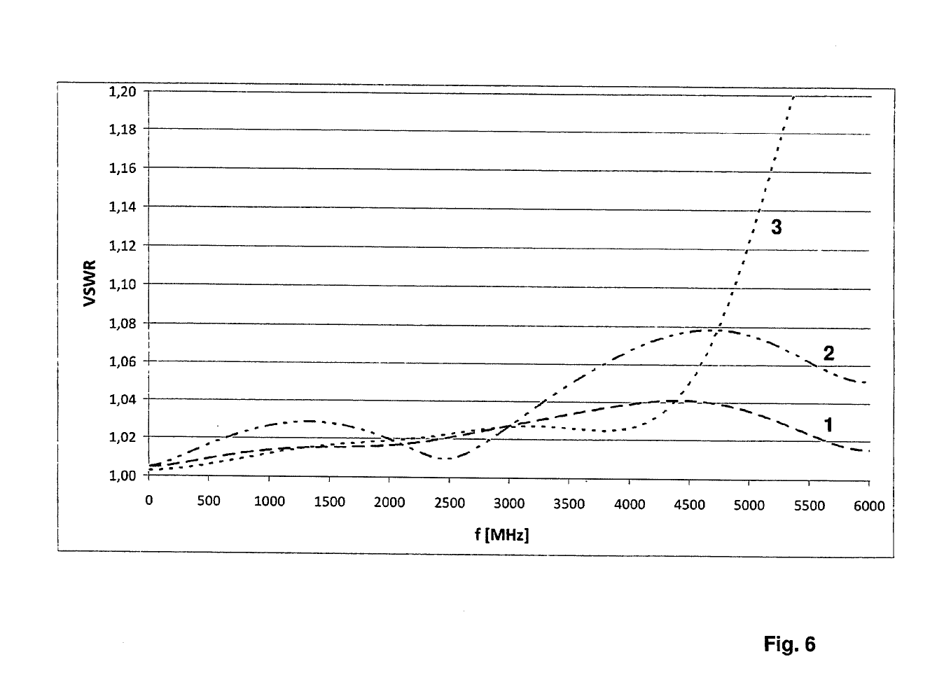

In FIG. 6 a graph is shown for comparing the standing wave ratio between a straight (Function 1), a corrugated sheath cable bent according to the invention with angular plug connector (Function 2), and a conventionally bent angular plug connection with mountable plug connector (Function 3). The standing wave ratio is a measure for the standing wave, which arises along a waveguide due to reflection. In the case of a standing wave ratio close to the value 1, virtually the entire HF power fed in is transmitted through the transmission line into a load. This is the desired state if the line is used for energy transmission. With increasing values of the standing wave ratio, the reflected portion increases and thus the loss increases. In the illustrated graph, the so-called electrical voltage standing wave ratio (VSWR) is shown along the ordinate as a function of the frequency f of 0 to 6000 MHz, which is entered along the abscissa.

Starting from a straight, unbent corrugated sheath cable, to which a straight connector is attached to feed in a HF signal, VSWR values from close to 1 up to 1.04 maximum are shown. Using a corrugated sheath cable bent according to the invention, VSWR values in the range of 1 and maximum of 1.08 in the specified frequency range of 0 to 6000 MHz can be achieved. By contrast, in the case of a corrugated sheath cable conventionally assembled with an angular plug, a clear increase of the VSWR value is shown at frequencies from approximately 4500 MHz.

In addition, the simple structure of the angular plug connector formed according to the invention opens up, in view of a reduced number of parts, a significant reduction of intermodulation risks that occur definitely in conventionally formed angular plug connectors already due to their complex and multi-component structure.

### REFERENCE LIST

1 Corrugated sheath cable
2 Cable outer conductor
3 Cable dielectric
4 Cable inner conductor
41 End of the cable inner conductor
42 Plug inner conductor
5 Cable sheath
51 Cable sheath end for angular plug connection
52 Cable sheath end for straight plug connection
6 Plug external conductor
61 Accommodating sleeve
62 Solder connection
7 Insulating support
8 Union nut
9 Seal
10 Covering
11 Bending guide
12 Retaining means
13 Recess
14 Bending guide
15 Clamping/tensioning element
16 Internal surface of a cable outer conductor corrugated guide
17 Internal surface of a cable outer conductor corrugated guide
18 Retaining means
19 Rolling or sliding body
20 Guide unit
S Plug connector
h Overall height
F_{z} Tensile force
Fᵣ Bending force
F_{R} Retaining force

1. A method for producing an angular plug connection on a cable end of a HF coaxial cable including a cable inner conductor and a cable outer conductor, comprising:
providing a straight HF corrugated cable including the cable outer conductor comprising a metal corrugated tube which centrally surrounds the cable inner conductor and is embedded in a dielectric, has a line impedance Zₖ and has a minimum bending radius r_{k,min};
preparing the cable end by trimming the HF corrugated cable;
connecting a straight plug connector to the prepared cable end by joining the cable inner conductor with an inner conductor of the straight plug connector and the cable outer conductor of the HF corrugated cable with an outer conductor of the straight plug connector;
cold forming a region of the HF corrugated cable attached to the plug connector or separated from the plug connector by applying a bending force directed transversely to a longitudinal extent of the HF corrugated cable and a tensile force directed longitudinally to the HF corrugated cable to permanently bend the HF corrugated cable to have a bending radius r_{α}, wherein 0.2 r_{k,min}≦r_{α}≦0.9 r_{k,min}, which alters the line impedance Zₖ to a maximum of 1 ohm.

2. The method according to claim 1, wherein:
coating at least the bend of the HF corrugated cable with a plastic or an adhesive.

3. The method according to claim 1, comprising:
forming the HF corrugated cable to cause the plug connector to be joined to the cable end while the cable is releasably attached to a retaining means, which is guided pivotably relatively to a bending guide to form the bend; and wherein
the retaining means, including the plug connector joined to the HF corrugated cable is pivoted relative to the bending guide, the HF corrugated cable being attached to or following the plug connector and contacts the bending guide while an orthogonal bending force is applied to the bending guide, and an axial force is applied to the HF corrugated cable longitudinally to the HF corrugated cable in a region spaced apart from the plug connection and the axial force creates tensile stress within the HF corrugated cable during the pivoting of the retaining means.

4. The method according to claim 2, wherein:
forming the HF corrugated cable to cause the plug connector to be joined to the cable end while the cable is releasably attached to a retaining means, which is guided pivotably relatively to a bending guide to form the bend; and wherein
the retaining means, including the plug connector joined to the HF corrugated cable is pivoted relative to the bending guide, the HF corrugated cable being attached to or following the plug connector and contacts the bending guide while an orthogonal bending force is applied to the bending guide, and an axial force is applied to the HF corrugated cable longitudinally to the HF corrugated cable in a region spaced apart from the plug connection and the axial force creates tensile stress within the HF corrugated cable during the pivoting of the retaining means.

5. The method according to claim 3, comprising:
applying orthogonal force to the HF corrugated cable during pivoting of the retaining means relative to the bending guide.

6. The method according to claim 4, wherein:
applying orthogonal force to the HF corrugated cable during pivoting of the retaining means relative to the bending guide.

7. The method according to claim 5, wherein:
the orthogonal force is applied by guiding a rolling or sliding body relative to the bending guide which contacts the HF corrugated cable.

8. The method according to claim 6, wherein:
the orthogonal force is applied by guiding a rolling or sliding body relative to the bending guide which contacts the HF corrugated cable.

9. The method according to claim 7, comprising:
contacting the HF corrugated cable with the rolling or the sliding body which at least an eighth of a circumferential edge thereof.

10. The method according to claim 8, wherein:
contacting the HF corrugated cable with the rolling or the sliding body which at least an eighth of a circumferential edge thereof.

11. The method according to claim 1, comprising:
cold forming the HF corrugated cable which joins the straight plug connector to the cable end while the cable end is fixed to a stationary retainer.

12. The method according to claim 2, wherein:
cold forming the HF corrugated cable which joins the straight plug connector to the cable end while the cable end is fixed to a stationary retainer.

13. The method according to claim 1, wherein:
applying the bending force and the tensile stress during cold forming without altering an electrical diameter of the bend to vary more than 10% from an electrical diameter of a straight region of the HF corrugated cable.

14. The method according to claim 1, comprising:
bending the HF corrugated cable permanently to have a bending radius r_{α}, where 0.4 r_{k,min}≦r_{α}≦0.6 r_{k,min}, while the HF corrugated cable is attached to or follows the straight plug connector.

15. The method of claim 1 wherein:
the angular plug connector includes a 90° bend and a mating plug connector.

16. The method of claim 2 wherein:
the angular plug connection transmits frequencies greater than a 4 GHz while providing measuring or calibration.

17. The method of claim 7 wherein:
the angular plug connection transmits frequencies greater than 4 GHz while providing measuring or calibration.

18. The method of claim 9 wherein:
the angular plug connection transmits frequencies greater than 4 GHz while providing measuring or calibration.

19. The method according to claim 2, comprising:
bending the HF corrugated cable permanently to have a bending radius r_{α}, where 0.4 r_{k,min}≦r_{α}≦0.6 r_{k,min}, while the HF corrugated cable is attached to or follows the straight plug connector.

20. The method according to claim 3, comprising:
bending the HF corrugated cable permanently to have a bending radius r_{α}, where 0.4 r_{k,min}≦r_{α}≦0.6 r_{k,min}, while the HF corrugated cable is attached to or follows the straight plug connector.
